(19) United States
(12) Patent Application Publication
(10) Pub. No.: US 2006/0024633 A1
(43) Pub. Date: Feb. 2, 2006

(54) Kiln lip position control assembly

(76) Inventors: Eduard Levin, Thornhill (CA); Jeffrey Lee Sawyer, Wichita, KS (US)

Correspondence Address: JEFFREY L. SAWYER, 2405 NORTH SHEFFORD COURT, WICHITA, KS, 67205, US

(21) Appl. No.: 10/940,364

(22) Filed: Sep. 14, 2004

(30) Foreign Application Priority Data
Jul. 30, 2004 (CA) 2.474.194

(51) Int. Cl. F27D 1/18

(52) U.S. Cl. 432/250

(57) ABSTRACT

High-temperature kilns for manufacturing ceramic, glass and other products with lids on top are equipped with devices for lifting and lowering kiln lids. In this invention, a Kiln Lid Position Control Assembly is used for mounting and controlling a lid on a kiln body, wherein its hinges are fixed on the lateral sides of the kiln and on its rear. The lateral hinges are assisted by springs. A hinge mounting such as this, allows the lid to open upward, and meanwhile shift the lid to the rear side of the kiln. This facilitates lifting and lowering of a kiln lid, increasing the safety while working with the kiln, and preventing deformation of the kiln.

### BACKGROUND OF THE INVENTION

1. Field of the Invention

This invention belongs to the class of technical devices which are specifically designed to control, lift and lower lids and hatches of reservoirs and storage tanks, which are used for storage or processing of material and products. In particular, the invention can be used for control, closing and opening of kiln lid designed for ceramic, glass-ware and other materials, when it is necessary to provide sealing contact of a kiln lid and kiln body, to prevent heat loss, to facilitate control of a kiln, to facilitate lifting and lowering a lid, to provide safety of work and kiln and to eliminate possibility of kiln lid's spontaneous falling.

The device includes pivot hinges and arms which allow kiln lid to move regarding the kiln body. The hinges are fabricated and assembled in such a manner that the kiln lid goes up and slides aside while kiln is opening instead elevating the kiln lid, and slides up front and goes down when kiln is closed.

The invention has essential advantage compared with existing devices of kiln lid operating devices.

First, it facilitates elevating and operating the lid in any of its positions.

Second, it prevents the lid's drop in the position when the kiln is open.

Thirdly, it eliminates necessity of installation of locks and lock devices. The number of details in the device is minimal, and that reduces kiln price and facilitates service and transportation. This device can be easily assembled and mounted on existing kilns, as well as it can be assembled and mounted when manufacturing new ones.

In addition, the device is simple to repair; its components are replaced easily, which feature is essential for those customers who are out of service centers area.

2. Description of Prior Art

There are a number of well known devices operating the position of kiln lids.

Typical solutions are shown, for example, in the following United States of America patents:

| | |
|---|---|
| 3958923 | Duncan, Richard F. |
| 4106159 | Cook, Ronald Janney |
| 4207061 | Ikenaga, at al |
| 4464548 | Burmeister; Lewis H. |
| 5970209 | Toyokura; Yasuhiro |
| 5910006 | Conroy; Michael D., Johnson; cybulski; Claude E., |
| | Cybulski; Eric R. |

Kilns manufactured by Cone Art, Scutt, Paragon etc. represent the standard design of mounting the kiln lid to the kiln body through hinges, which fix hinges on a back part of the lid and allow open the kiln by elevating the lid's front. This technique requires significant efforts, especially when operating average-size and larger kilns. Besides, it is not safety enough to operate with kiln, when kiln is open—the lid can not be fixed in the open position and can fall down easy (L&L Kiln Mfg Inc. kilns.—Clay Times magazine, v.10, #4, July/August 2004—www.hotkilns.com.); or the lock is inconvenient in work—while release locked support arm from one side, the same arm from the other side can be locked occasionally (Cone Art kilns—A sales catalogue, identified as “Bulletin Shimpo Ceramics, Cone Art Kilns, Nidec-Shimpo American Corpaoraton, 1701 Glenlake Ave. Itasca, Ill., 60143—www.shimpoceramics.com.).

To ease elevating effort, Cone Art kilns are equipped with gas springs; however, in the process of warming up the kiln lid may lift slightly due to gas pressure increase and therefore jut out of the kiln dimensions (A sales catalogue, identified as “Shimpo Ceramics, Catalogue CER—0304, Nidec-Shimpo American Corporation, 1701 Glenlake Ave. Itasca, Ill. 60143 www.shimpoceramics.com.). This factor results in energy losses, derating of kiln's temperature, deformation of kiln's body and jeopardizing safety of thermal injuries.

Finally, the Canadian Patent Number CA2238110, issued to Joy Johnson and Michel Conroy on May 20, 1998, discloses a ‘Kiln Lid Mounting Assembly,’ which contains rods (bars?) mounted above the lid and attached to the kiln body by a hinge and springs to ease elevating the lid.

This technique ease lid lifting, but not effective enough if spring tension is low. If the spring tension is increased it leads to kiln deformation and brick damage. Kiln Lid Mounting Assembly consists of large number of parts, requires specific tool and qualified personnel to assemble or to fix it. Besides, it is not safety enough to operate with kiln, when lid is lifted—the lid can fall down easy. It is apparent from the foregoing that the prior art fails to teach, or even suggest, an Kiln Lid Control Assembly which performs light kiln lid lifting, secures lid positions “Open” and “Closed” and does not deform the kiln body.

### SUMMARY OF THE INVENTION

The invention is included into the class of devices specifically designed to operate, lift (elevate) and lower kiln lids; it includes double-axis hinges located on the rear side of the kiln's body and attached to it with its base and to the lid with its upper part; it includes double-axis arms attached to pivot on both sides of the lid and to other axes on the plate of kiln body, support chain between kiln body and double-axis hinges. Double-axis hinges consist of the drop housing and two brackets at the top and bottom parts. One of the brackets is mounted on the rear side of the lid, and another one is attached to the kiln body. Holes in hinges at the junction of brackets and hinges are oval. The brackets are attached to a hinge with the axes.

The double-axis arms have the shape of strip with holes at ends; they are mounted, on the one side, on the axes attached to the kiln lid, and, on the other side, on the axes attached to a kiln body.

Arms rotate around an axis in the bottom part or middle part of each arm. If the arm rotates around an axis in the bottom part, the spring is attached to the middle of the arm. If the arm is attached to the kiln using the hole in the middle part of the arm, each spring is installed between the bottom part of the arm, and the hinge on the kiln body.

There are front and back support levers mounted to the kiln body. Front support levers reduce power to lift a kiln lid while kiln is opening; back support levers reduce power to lift a lid while closing a kiln as well as prevent kiln body from damages.

Levers are direct straight or curved racks with a fixed stop at the one end and have a hole in the central part for attaching on an axis, and a number of holes in the bottom part for spring mounting of the hinge and adjustment of its position. To simplify work of the device, the double-axis arm and the lever can be mounted on one axis. The fixed stop is intended to serve for amortization of the lowering kiln lid and structurally is a platform, which is perpendicularly located on the surface of the lever and makes contact with the double-axis arm, thus compensating the weight of the lid tightening up the spring.

The springs are fixed to the brackets of the plate, which has holes for installation of the spring between this hole and the hole in the bottom part of the levers and to mount it on the kiln body.

As option, front and back support levers made as one Y-shaped piece with spring connected to kiln body by adjustable bolt with ring from one side, another spring end is mounted to the lever.

### BRIEF DESCRIPTION OF THE DRAWINGS

FIG. 1 is a side view of the kiln with closed lid of the present invention;

FIG. 2 is a side view of the kiln with open lid of the present invention.

FIG. 3 is a plan view of the hinges with stop of the present invention.

FIG. 4 is a plan view of the bracket of the present invention.

FIG. 5 is a plan view of the hinges designed as one piece of the present invention.

FIG. 6 is a side view of the kiln with closed lid and mounted front support lever of the present invention.

FIG. 7 is a side view of the kiln with open lid and mounted front support lever of the present invention.

FIG. 8 is a side view of the kiln with closed lid and mounted front and back support levers of the present invention.

FIG. 9 is a side view of the kiln with opened lid and mounted front and back support lever of the present invention.

FIG. 10 is a plan view of the kiln with Y-shaped lever of the present invention.

FIG. 11 is a top view of the kiln with closed lid and mounted support levers of the present invention—spring are not shown.

FIG. 12 is a side view of the kiln with closed lid and springs of the present invention;

FIG. 13 is a side view of the kiln with open lid and springs of the present invention.

### DESCRIPTION OF THE PREFERRED EMBODIMENT

With reference to the drawings and, in particular, with reference to FIG. 1, 2, 3 the Kiln has a jacket 1, which surrounds fireproof bricks 2; the lid 4 is tied up with strengthening belt. The lid is equipped with handle 3 for managing, lifting and lowering. The Kiln Lid Position Control Assembly 3 includes I-shaped hinges 10, attached to lid 4 on the rear side and on the kiln body as well, the arms 6, which is fixed along axes 5, 16 to the lid and kiln body, support chain 14 between kiln body and hinges 10. With reference to FIG. 1 each hinge has holes on both sides, hole 11 for connection with support chain 14 and mounted to the kiln body with brackets 8 and 12 that attached to the rear side of the lid and kiln body. Top hole 9 made as oval. The hinges rotate around the brackets on the axes 13. The arm is mounted on axis 5 and 16. To restrict lid move in the position “kiln open,” the hinges are equipped with support chain 14. The support chain is attached to the hinge 10, on the one side, and to the kiln body by using the brackets 15. The kiln body's central and rear parts are reinforced with the metal plate 7, which straddles the jacket. The spring 21 is installed between bracket 15 and arm 6.

With reference to FIG. 3 hinges and support chain can be replaced with two L-shaped hinges 29 with holes 9, 28 at the top and bottom ends.

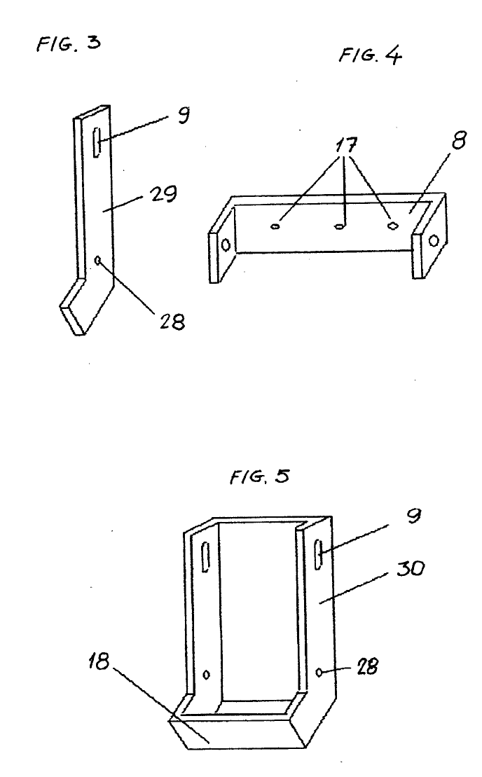

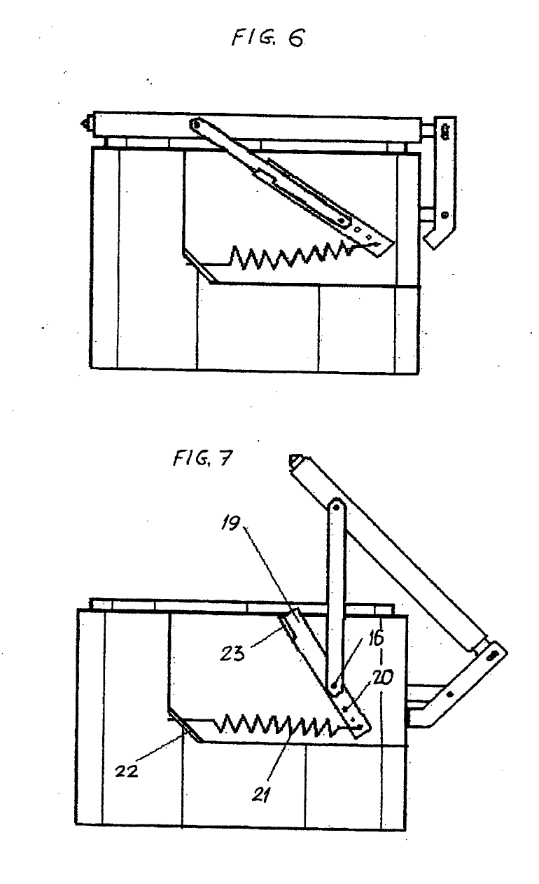

With reference to FIG. 4 each bracket 8 has holes 17 to attach it to the lid and kiln body.

With reference to FIG. 5 hinges and support chain can be replaced with hinge 30 made as one piece with support plate 18.

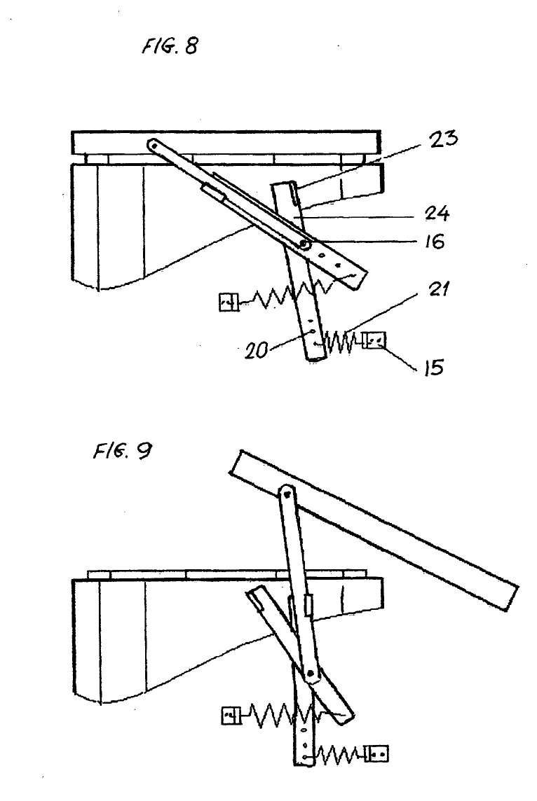

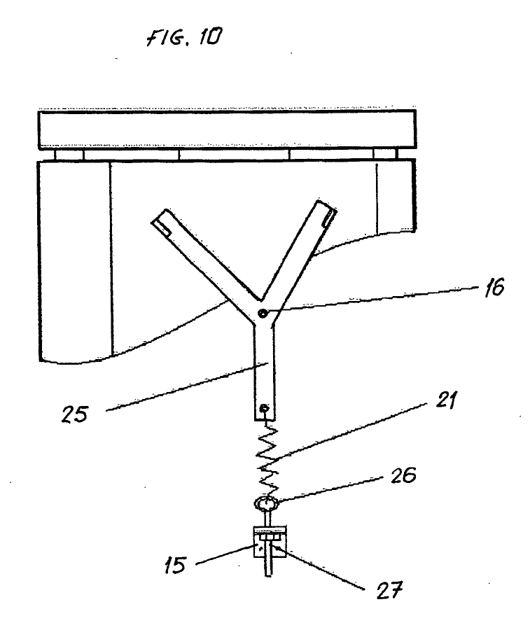

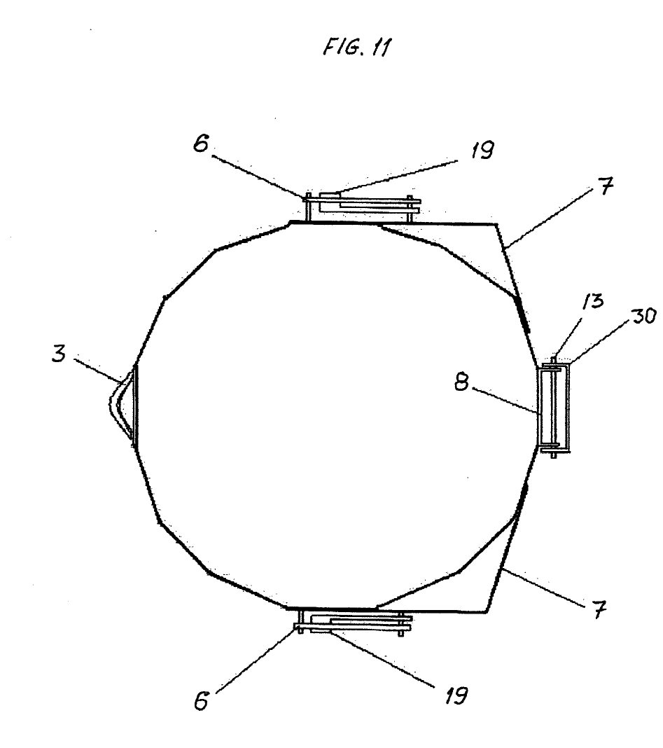

With reference to FIG. 6 and FIG. 7 there are optional front support levers 19 with springs 21, the levers rotate around axes 16. The levers have arm supports 23, which gear the APM when lowering the lid and to decrease pressure of the lid on the kiln, as well as to facilitate lid lifting. The springs are attached to the levers, on the one side, and to the kiln body by using the brackets 15 as with reference to FIG. 1 or bracket 22 made from folded plate in the low corner of plate 7 with drilled hole in it. The levers have a number of holes 20 to adjust the power of lid lifting. With reference to FIGS. 8 and 9 back support levers 24 with arm supports 23 mounted on the kiln body to decrease the pressure on the rear side of the kiln, using spring 21, while kiln is open as well as to facilitate lid lifting and control. With reference to FIG. 10 front and back support levers made as one Y-shaped piece 25 with spring 21 connected to adjustable bolt 27 with ring 26 from one side, another spring end is mounted to the lever 25.

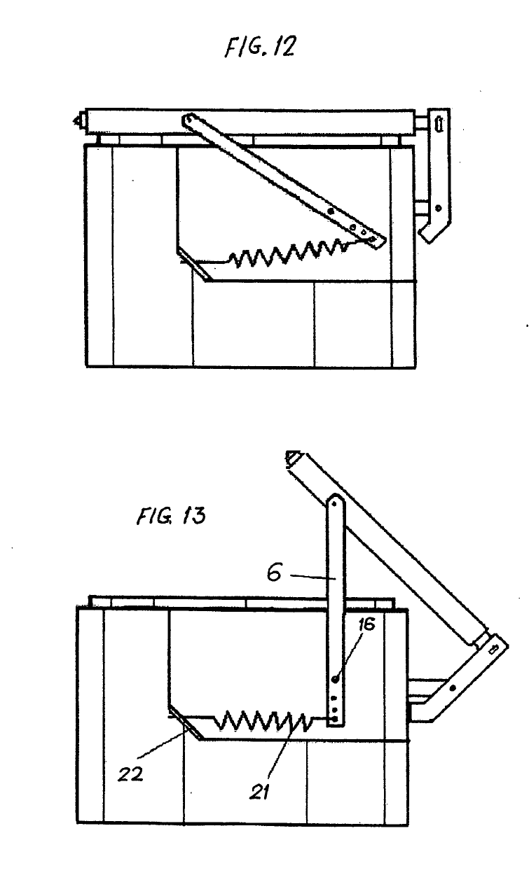

With reference to FIG. 12 and FIG. 13, there are optional springs attached to arms 6 and brackets 22. Arms 6 have a hole in the middle and rotate around axis 16 while opening and closing kiln.

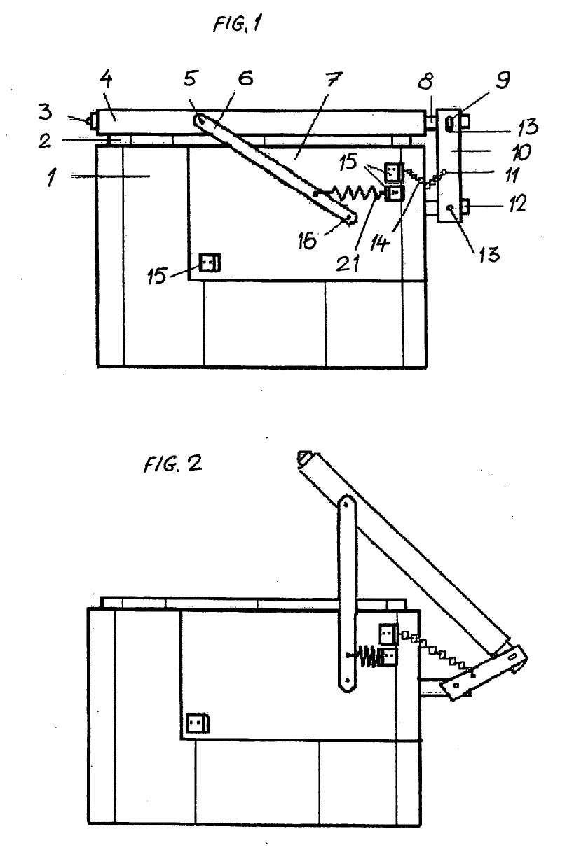

As seen from FIG. 1-13, the Kiln Lid Position Control Assembly allows essentially facilitate work with the kiln, as instead of lifting the kiln lid, a user lifts the lid supported by the hinges in different points around the kiln lid and shifts it over the kiln until lid is fully opened. To close the lid, a user pulls the lid from the rear position and lowers it, while holding its front panel until lid if fully closed.

The embodiments of the invention in which an exclusive property or privilege is claimed are defined as follows:

1. A Kiln Lid Position Control Assembly for operating kiln lid position including double-axes hinges with brackets which are mounted to the kiln lid and its body in the rear part of the kiln, the support chain to restrict the lid's move, the arms mounted to the axes in the central part of the lid, on the one side, and through the plate on axes to the kiln body, on the other.

2. A Kiln Lid Position Control Assembly recited in claim 1 wherein said support chain and hinges changed with plates prolonged with stops.

3. A Kiln Lid Position Control Assembly recited in claim 1 wherein said support chain and double-axis hinges changed with U-shaped plate made as one piece with supporting plate.

4. A Kiln Lid Position Control Assembly recited in claim 1 wherein said the springs are attached to the arms and to the plate on the kiln body.

5. A Kiln Lid Position Control Assembly recited in claim 1, 2, 3 wherein said levers with plates on one side are mounted onto the kiln body, each lever has a number of adjustable holes, springs assembled between brackets on the kiln body and levers.

6. A Kiln Lid Position Control Assembly recited in claim 4 wherein said each arm and proper lever mounted on one axis.

7. A Kiln Lid Position Control Assembly recited in claim 1, 2, 3, 4, 5 wherein said the spring brackets are manufactured by folding the plate body and drilling a hole at the angle of the plate.

8. A Kiln Lid Position Control Assembly recited in claims 1, 2, 3, 4, 5, 6 wherein said springs attached to the brackets through the bolts ended with rings, to gear the spring.

9. A Kiln Lid Position Control Assembly recited in claim 4 wherein said the levers are made as a curve shaped pieces.

10. A Kiln Lid Position Control Assembly recited in claim 4 wherein said levers combined as one Y-shaped piece.
